(19) United States
(12) Patent Application Publication
(10) Pub. No.: US 2008/0162451 A1
(43) Pub. Date: Jul. 3, 2008

(54) Method, System and Computer Readable Medium for Identifying and Managing Content

(75) Inventor: William J. Garrison, Warminster, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/617,882

(22) Filed: Dec. 29, 2006

(51) Int. Cl. G06F 17/30; G06F 17/00; G06F 7/00

(52) U.S. Cl. 707/5; 707/101; 707/104.1; 707/E17.017; 707/E17.006; 707/E17.001

(57) ABSTRACT

A method and system for managing media content is provided. The method includes extracting a signature from the media content in the electronic device. The method also includes retrieving a set of signatures. Further, the method includes comparing the signature with the set of signatures. Moreover, the method includes performing at least one action on the media content, based on the result of the comparison.

The invention generally relates to media content, and more particularly, to a method and system for identifying and managing media content in an electronic device.

### BACKGROUND OF THE INVENTION

People watch or listen to media content all the time. Movies, television shows and music are examples of media content. Usually, a particular piece of media content is stored in a media file. A media file is the actual data representation of media content in a physical form, such as a magnetic disk, optical disk or paper, or an electrical form such as in a semiconductor memory (e.g., RAM or ROM) or in signals such as packets being transmitted over a network. Many media files contain multiple pieces of media content. As an example, a broadcast television show recorded on a digital video recorder (DVR) usually contains the show itself with commercials interspersed throughout. A CD from a musical artist may typically include 5-10 songs on it. A DVD of a movie will not only have the feature film, but it may also have bonus features such as outtakes and interviews with the actors or directors.

Many media files will contain metadata that describes characteristics of the media content. For example, titles of songs and the artist's name can be stored as metadata in the same media file as the music. Thus, the user could hear the song being played over a set of headphones from a portable player and read the title of the song on a small display at the same time. An example of metadata is the ID3 tag in a Moving Pictures Expert Group (MPEG) I layer III (MP3) file. The ID3 tag enables identification of information, such as the title, the names of the artist and the album, and/or the track number of the MP3 file.

Some media files to not contain metadata or enough metadata wanted by the user. As an example, the media file storing a broadcast television program on DVR will have both the program and commercials. There is no metadata that can identify where in an entire media file the commercials are nor that can distinguish from one commercial from the next (e.g., distinguish between commercials for Brand X shampoo vs. Brand Y automobiles). Thus, there is no easy way for a user to skip over or replace commercials he is not interested in without fast forwarding and rewinding through the commercials and playing the desired program at normal speed. In some circumstance, content is stored into a media file without any metadata. The user may then have the song and can listen to it, but he does not know the artist's name so he cannot buy more music from that artist if he wants to.

Gracenote Media Recognition Service^{SM} from Gracenote® is used to identify a CD containing multiple songs that does not have metadata stored on it. It is believed that Gracenote Media Recognition Services^{SM} looks at the length of time of each song on a CD, the length of time of the CD and the number of songs on that CD. Once this data is determined, this data is compared against a known database for CDs using similar data. The service than identifies the entire CD and then matches each song with the songs it determines are on the CD. This service only operates on an entire CD. That is, it needs aggregate data about a plurality of pieces of media content, stored in one media file before it can recognize a CD. It cannot identify a single song or other piece of media content by itself nor can it identify one particular piece of content from a media file containing multiple pieces of content without first identifying the compilation first.

### BRIEF DESCRIPTION OF THE FIGURES

FIG. 1 is a block diagram of a media system used to identify and manage content;

FIG. 2 is a screen shot of a user interface used to input user selections for identifying and managing media content;

FIG. 3 shows a table of titles, types of media and corresponding signatures and partial signatures of the media; and

FIG. 4 is a flow diagram illustrating a method for identifying and managing media content.

### DETAILED DESCRIPTION

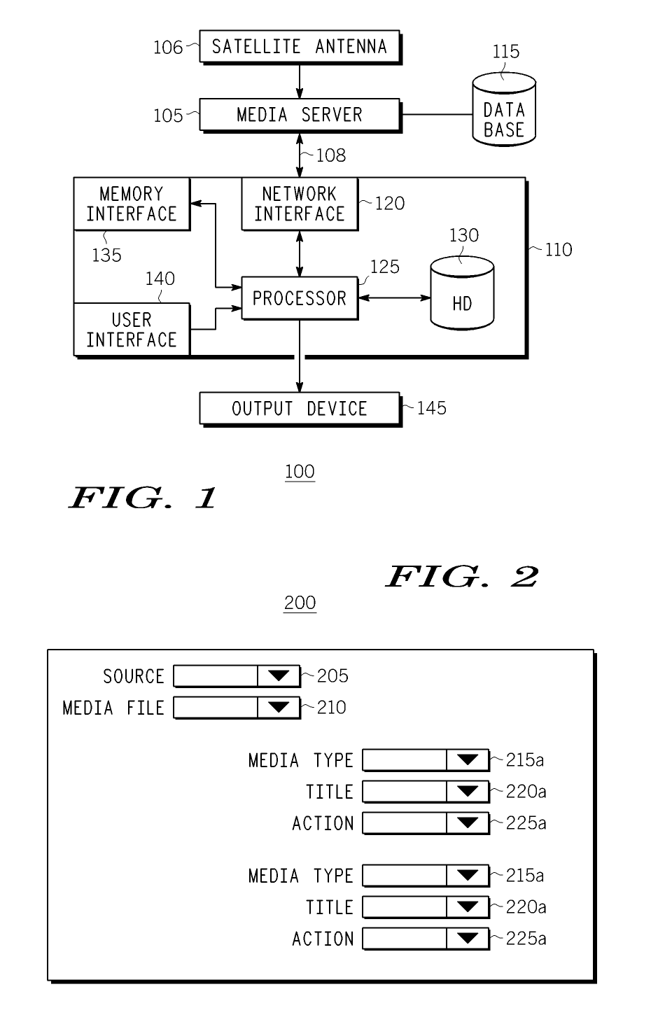

FIG. 1 is a block diagram of media system 100. Media system 100 includes a media server 105. A media server is a combination of hardware and software that transmits media files to a destination. Examples of media servers include cable head-ends, IP-based broadcasting sources and video-on demand servers. Media server 105 provides media content over a network 108 to a media processing system 110. Network 108 may be a hybrid fiber-coaxial cable network, a satellite network or a terrestrial broadcast RF network. Media server 105 is also coupled to a database 115. Database 115 typically stores media content such as television shows or movies. In one implementation, database 115 stores media signatures as will be described later. Media server 105 is also coupled to a satellite interface 106 for receiving media over a satellite downlink.

Media processing system 110 includes a network interface 120. Network interface receives signals from network 108. Network interface 120 processes those received signals. It performs such functions a tuning, demodulating and decrypting. The processed media signals are then forwarded to processor 125 for additional processing. Processor 125 decodes and performs filtering or enhancement on the data received from network interface 120. In one implementation, processor 125 identifies and manages content as will be described later. A processor is any computer hardware and software combination that can execute instructions and perform logical and arithmetic operations on data. Some of these instructions control processor 125 so it identifies pieces of content from a media file and/or performs an action on the identified content.

Processor 125 is also coupled to data storage 130. In certain implementations, data storage 130 is either a magnetic hard disk or semiconductor memory like RAM or ROM. In one implementation, data storage 130 stores both instructions to control the operation of processor 125 as well as content. Processor 125 is also coupled to memory interface 135. In some implementations this memory interface interfaces with a Digital Versatile Disk (DVD) or a semiconductor memory.

User interface 140 is also coupled to processor 125. User interface 140 receives signals from a user so that the user can select the source of media content (e.g., network interface 120, hard drive 130 or memory interface 135 and can select one particular piece of media content from that source. For example, if the hard drive 130 has twenty movies stored on it, the user can select which of those 20 movies to watch via user interface 140. User interface 140 also allows the user to input selections to manipulate certain pieces of content based on their signatures as will be described later. In some implementations user interface 140 is coupled to a remote control, a mouse or a keyboard (not shown).

After processor 125 processes the received media data from any source, it outputs the processed media data to an output device 145 for consumption by the user. Examples of output devices include televisions, computer monitors and speakers.

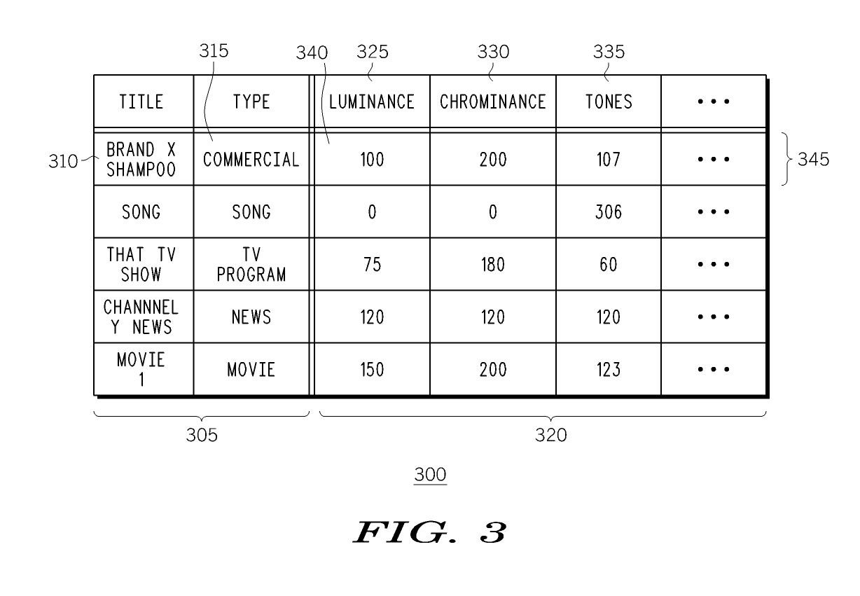

FIG. 2 is a screen shot 200 of a user interface used to input user selections for identifying and managing media content. Box 205 allows a user to input the source of the media files to be identified and managed. Examples of sources include a cable network, satellite network, a local hard drive or a local DVD player. To assist the user in making this entry, a drop down box is provided.

In box 210 the user enters the name or title of the media file. This box is particularly useful when the media source contains a plurality of media files. As an example, a hard drive may contain dozens or hundreds of stored media files. If the user selects a broadcast source in box 205, the user would not necessarily be prompted to input a media file name in box 210. Processor 125 would automatically identify and manage whatever content the user selects to consume based on the channel or broadcasting source the user selects. In one sense, the processor 125 will identify and manage content based on the channel the user selects.

In boxes 215a and 215b, the user selects the type of media content in the media file selected in box 210 he wants identified and managed. As an example, the user may wish to identify and manage commercials in a media file containing both commercials and a television program. To further refine what the user wants to identify, he may optionally enter a title for media types in boxes 220a and 220b. Thus the user may manage one piece of content different from another even though both have the same type. The user would allow the titles to distinguish between the same type pieces of content. In another implementation, title boxes 220a and 220b may be omitted.

In boxes 225a and 225b, the user selects the type of action he wants performed on the identified piece of content. That is, the user can skip over the identified content, replace the identified content with other content, fast forward through the identified content, store it for later consumption or render the identified content at normal speed.

FIG. 3 shows an illustrative data table 300 that stores media types and corresponding signatures. Data table 300 is broken into two sections 305 and 320. Section 305 contains two columns. In one column is a title or other identifier that identifies the content. As an example, entry 310 stores a title for brand X shampoo. In the other column, the type of media is stored. Thus, entry 315 stores the entry “commercial” that corresponds to the identifier in entry 310.

Section 320 stores partial signatures and full signatures. Column 325 stores luminance values and column 330 stores chrominance values for the various pieces of content. It should be noted that multiple chrominance values will typically be stored relating to a plurality of colors. For the sake of clarity, only one is shown in data table 300.

Column 335 stores data about tones or notes in a musical piece. Each entry in section 320 is a partial signature. That is, the luminance value in entry 340 tends to indicate that the piece of media content is the commercial for brand X shampoo. The entire row 345 in section 320 is the full signature for the brand X shampoo commercial. It should be noted that some entries in a row in section 320 may be filled with blank data. For example, a piece of musical content will not have a luminance or chrominance value. Thus, the entries for that piece of content will be 0 or some other predetermined value.

A signature is one or more characteristics about a piece of media that tends to identify that piece of media over other pieces of media. A signature may include partial signatures. A partial signature is one characteristic about a piece of media that tends to identify that piece of media over other pieces of media. Characteristics can include a luminance value either over a particular area of a field or frame or an average over the entire field or frame, a chrominance value over either an area or average over a complete field or frame, the order of a few notes from a piece of audio content, the syncopation of notes in a piece of audio content, the average pitch of a few notes from a piece of audio content etc. The signature is typically extracted in the first couple of seconds of playing the content at normal speed. That is, typically only the first 100-300 frames of video content or tones from an audio content need to be analyzed. Thus, to obtain a signature, processor 125 obtains values for such characteristics as chrominance, luminance and/or tones for a small portion of the content being rendered or stored. The values, if more than one is extracted, are then combined to form a single signature.

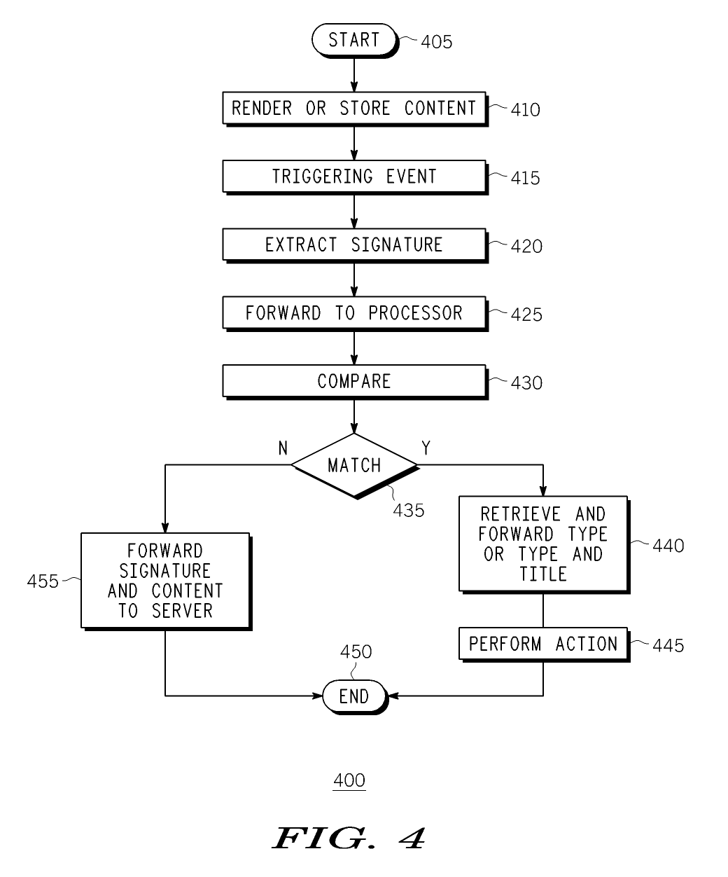

FIG. 4 shows a flow diagram 400 illustrating a method for identifying managing media content. The method is initiated at step 405 after the user has selected how and what pieces of media content to identify and mange using a user interface such as interface 200 in FIG. 2. At step 410 the media processing system 110 begins to output and render or store content for the user. This can be equivalent to a user tuning to a particular channel to watch a movie or the hard disk storing a program.

At step 415, a triggering event occurs. A triggering event is a change in at least one partial signature of the content. As an example, a commercial may have different luminance and chrominance values than the movie it is inserted into. Thus, a sudden or large change in these values may indicate a commercial the user wants to act upon (e.g., skip over). However, it should be noted that a change in luminance values alone may not indicate a commercial. For example, a scene change from day to night would also exhibit a large luminance value change rather quickly. Yet, the night scene is not a commercial to be skipped. Thus, further analysis is needed. At step 420, processor 125 extracts either a partial or a full signature from the media content begin rendered. As stated earlier, the extracted signature could be a partial signature (e.g., luminance value 325 only) or a full signature (e.g., record 345).

At step 425, the extracted signature is forwarded to a processor where it will be compared against other signatures. Referring to FIG. 1, media processing system 110 may forward the extracted signature to media server 105. Alternatively, the extracted signature may remain with media processing system 110 and not be forwarded. Whether or not to forward the extracted signature out of media processing system 110 depends on where the database of stored signatures resides. If it resides in database 115, the extracted signature will be forwarded to media server 105. If it resides in data storage 130, the extracted signature will stay with media processing system 110.

At step 430, the processor compares the extracted signature with a set of signatures stored in a database such as 115 or 130. If a match is determined at step 435, the process continues at step 440 where the type of content is extracted by or and forwarded to processor 125. In an alternative implementation, the type and title of the content are extracted by or forwarded to processor 125. Thus, if the extracted signature matches a saved signature for a commercial, processor 125 will return the type (e.g., commercial) or the type and title (e.g., Brand X Shampoo) to processor 125. Processor 125 uses this type or type and title to select an action to perform at step 445 via the data entered in boxes 225a or 225b.

Actions can be in many forms. One illustrative action is to fast forward the rendering through the content with the matched signature. Thus, if the piece of content with this signature is a commercial embedded in a media file that also contain a television program, the user can instruct processor 125 to fast forward through the commercial. Alternatively, the media processing system 110 may replace the original commercial with another commercial that is more up to date or better suits the user (e.g., if the user likes trucks, a commercial for a car could be replaced with a commercial for a truck). After the action is performed, the process ends at step 450.

If at step 440, the processor extracts both the type and title of the piece of media content, the user can perform different actions. For example, if the user is a brand loyalist for trucks from Company A, and he wants to view commercials from Company A, he can use the title information, which should include the name of the company, to select commercials from the media file to be played at normal speed. Thus, the user can learn about what Company A is offering in terms of trucks and pricing. Since the user is a brand loyalist, he won't be interested in commercials from automobile manufacturer Company B and the user can use the title information to identify and fast forward or skip over commercials from Company B.

If the extracted signature does not match any entries in the database at step 435, the processor packages the signature with the media content it came from and sends it to server 105 at step 455. Once there, the media content and signature are examined so that the signature and type of content can be added to the database. The process then ends at step 450.

One comparison technique that can be used in step 425 to compare signatures is a Bayesian statistical analysis. This type of analysis is performed in email spam filtering as is known to those of ordinary skill in the art.

The process described above FIG. 4 may be implemented in a general, multi-purpose or single purpose processor. Such a processor will execute instructions, either at the assembly level, compiled level or machine level, to perform that process. Those instructions can be written by one of ordinary skilled in the art following the description of FIG. 4 and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (removable, non-removable, volatile or non-volatile), packetized or non-packetized wireline or wireless transmission signals.

The process 400 described in FIG. 4 may also be implemented at various times in the “life” of a piece of content. For example, process 400 may be implemented as the content is streaming or being received into media processing system 110. Thus, commercials can be replaced as soon as they are identified. Alternatively, process 400 may be implemented as content is being received on network interface 120 and stored on hard drive 130. Thus, before a full commercial is stored, it can be identified and either erased from hard drive 130 or replaced with a more suitable commercial. Process 400 may also be performed in the background. If the user stores a 2 hour movie on hard drive 130, processor 125 can go through the media afterwards, but before the content is rendered, and perform actions on the identified pieces of content. Finally, process 400 may be performed as content is being read off of hard drive 130 and rendered on output device 145.

If process 400 is performed on stored media files (e.g., on hard drive 130), more partial signatures may be obtained in order to identify the media content. As an example, many commercials end with the product being centered in the frame with a tag line or phrase printed around it. Processor 125 can identify the last 100 or so frames of a commercial by looking backwards from a triggering event. Once processor 125 has identified the end of the commercial, particular areas of the frames may be analyzed for luminance or chrominance values. This is particularly useful for identifying commercials where the product has a particular trade dress (e.g., shape and color to a bottle). The chrominance values can be analyzed to determine the shape and color of the item and use those values as partial signatures to identify the commercial. In this example, the luminance and chrominance values of the entire frame are supplanted by luminance and chrominance values of a particular are of multiple frames or fields.

What is claimed is:

1. A method for managing media content in an electronic device, the method comprising:
extracting a signature from the media content;
comparing the extracted signature against a database of signatures; and
performing an action on the media content based on a result of the comparison.

2. The method of claim 1, wherein the action is skipping the media content.

3. The method of claim 1, wherein the action is replacing the media content.

4. The method of claim 1, wherein the action is compressing the media content.

5. The method of claim 1 wherein the extracted signature is a partial signature.

6. The method of claim 1, wherein the action is rendering the media content at normal speed.

7. The method of claim 1, wherein the action is storing the media content.

8. A system for managing media content comprising:
an interface that receives the media content;
a processor that processes the media content received by the interface;
an output device that renders the media content output by the processor; wherein
the processor operates so as to
extract a signature form the media content;
compare the extracted signature against a database of signature; and
perform an action on the media content if the extracted signature substantially equals a first signature from the database.

9. The system of claim 8 wherein the interface is coupled to a cable network.

10. The system of claim 8 wherein the interface is coupled to a satellite network.

11. The system of claim 8 further comprising:
a data storage unit coupled to the processor that stores the media content.

12. A computer readable medium encoded with a computer program wherein the computer program includes instructions that instruct a processor to perform a method comprising:
extracting a signature from media content;
comparing the extracted signature against a database of signatures; and
performing an action on the media content based on a result of the comparison.

13. The computer readable medium of claim 12, further comprising instructions so the action performed by the processor is skipping the media content.

14. The computer readable medium of claim 12, further comprising instructions so the action performed by the processor is replacing the media content.

15. The computer readable medium of claim 12, further comprising instructions so the action performed by the processor is compressing the media content.

16. The computer readable medium of claim 12, further comprising instructions so the action performed by the processor is rendering the media content at normal speed.

17. The computer readable medium of claim 12, further comprising instructions so the action performed by the processor is storing the media content into a memory device.
